(19) United States
(12) Patent Application Publication
(10) Pub. No.: US 2008/0116692 A1
(43) Pub. Date: May 22, 2008

(54) Arrangement For Converting Kinetic Energy Of Ocean Currents Into Electric Energy

(76) Inventors: Goran Emil Lagstrom, Stockholm (SE); Sven-Erik Ekbach, Stockholm (SE)

Correspondence Address: SCHWEGMAN, LUNDBERG & WOESSNER, P.A., P.O. BOX 2938, MINNEAPOLIS, MN, 55402, US

(21) Appl. No.: 11/794,406

(22) PCT Filed: Dec. 28, 2004
(86) PCT No.: PCT/SE04/02021

§ 371 Date: Nov. 28, 2007

(51) Int. Cl. F03B 13/10; F03B 13/22

(52) U.S. Cl. 290/54; 415/7; 290/53

(57) ABSTRACT

Arrangements for converting kinetic energy of ocean currents into electric energy, comprising a floating body carrying a plurality of so called Savonius turbines (26), each of which having at least two blades (34) with a substantially semi-circular cross-section for transferring a rotary motion of the turbine to an electric power generating unit (40). The floating body comprises elongated, mutually spaced and interconnected pontoons (12) and defining between the pontoons a narrowed through-passage (18) for water currents. At least one pair of Savonius turbines being suspended vertically across the through-passage (18) so as to extend downwardly from an upper deck (14) into the through-passage. Alternatively, the Savonius turbines are rotatably mounted at opposite ends in the pontoons so as to extend horizontally above each other across the through-passage. The adjacent turbines are configured to rotate in opposite directions.

### BACKGROUND OF THE INVENTION

1. Technical Field

The present invention relates to an arrangement for converting kinetic energy of ocean currents into electric energy, comprising a floating body carrying a plurality of so called Savonius turbines, each turbine having an elongated cylindrical configuration and comprising at least three longitudinally adjacent, consecutive turbine rotor sections. Each such rotor section has at least two blades with a substantially semi-circular cross-section, and the blades in adjacent rotor sections are preferably mutually circumferentially spaced 360°/n, where n is the number of the longitudinally adjacent turbine rotor sections. Each turbine further includes a rotor shaft at one end thereof for transferring a rotary motion of the turbine to an electric power generating unit, such as an electric generator, on the floating body through a mechanical transmission.

2. Prior Art

An arrangement of the kind described above is generally known from e.g. WO 99/20896 and to which reference is drawn to herein. Thus, it is known to arrange such Savonius turbines individually on a respective buoy and anchor them e.g. in a straight line or in some other configuration, depending on the normal variations of the direction of the ocean current. The individual buoys are anchored, preferably with the help of three anchor chains with anchors displaced 1200 in relation to each other, so that the buoys cannot rotate with the turbine. A plurality of Savonius turbines may also be suspended in various formations from a common pontoon anchored in ocean currents or in places where the tide or river outlets create such water flows or currents in the sea.

When such Savonius turbines rotate due to the speed of the water flow, they are exposed for a force in the direction of the flow (x-direction) as well as a force directed normal thereto (y-direction), i.e. the so called Magnus-effect, the direction of which depending on the rotational direction of the turbine. In the prior art solution discussed above, the angle of deflection of the Savonius turbines is minimized by providing them with a suitably adapted counterweight at its distal (lower) end.

### SUMMARY OF THE INVENTION

It is an object of the present invention to provide an improved arrangement of the Savonius turbines such that they are better mutually balanced and may produce more rotary and electric energy when mounted to a vessel or a floating body, such as pontoons.

To this end, according to one aspect of the invention, the arrangement described above by way of introduction is characterized in that the floating body comprises at least two parallel, elongated, mutually spaced, interconnected pontoons and defining between the pontoons a narrowed through-passage for water currents, and that at least one pair of Savonius turbines are suspended vertically across the through-passage so as to extend downwardly from an upper deck into the through-passage and configured to rotate in opposite directions.

Alternatively, according to another aspect of the invention, the Savonius turbines may be rotatably mounted at both opposite ends thereof in the pontoons so as to extend horizontally above each other across the through-passage and configured to rotate in opposite directions.

In both the inventive embodiments, i.e. with vertically or horizontally disposed Savonius turbines, the latter are thus arranged in pairs, and adjacent turbines are rotatable in opposite directions so that the forces created by the Magnus-effect are directed in opposite y-directions to equalize one another, thereby obtaining a substantially dynamically stable condition of the turbines and minimized deflections thereof. Also, by placing the Savonius turbines in a narrowed through-passage between two parallel, elongated, mutually spaced, interconnected pontoons, an increased speed of the water flow therethrough will increase the rotational speed of the turbines. Hence, as the generated power of the turbine increases with the third power of the water flow speed, the power outlet of the turbines will increase substantially, thereby enabling lower investment costs for the plant and a substantially lower energy (kWh) price for the energy produced, which is especially important when the arrangement is applied in sea environments of relatively slow water flows.

Other features and advantages of the arrangements of the present invention are defined in the following dependent claims and will be described more in detail below in conjunction with the accompanying drawings.

### BRIEF DESCRIPTION OF THE DRAWINGS

FIG. 1 is a schematic side elevational view of a first embodiment of the arrangement of the invention;

FIG. 2 is a schematic plan view of the arrangement in FIG. 1;

FIG. 3 is an enlarged schematic cross-sectional view of the blade configuration of one rotor section of two adjacent Savonius turbines rotatable in opposite directions;

FIG. 4 is a schematic side view similar to FIG. 1 of a second embodiment of the arrangement of the invention; and

FIG. 5 is a schematic plan view of the embodiment of FIG. 4.

### DETAIL DESCRIPTION OF PREFERRED EMBODIMENTS OF THE INVENTION

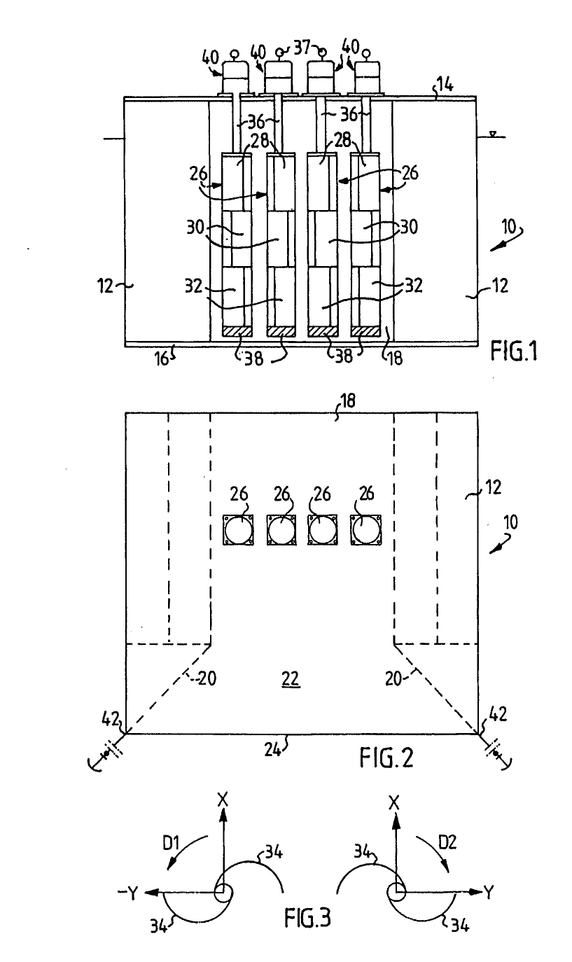

FIGS. 1 and 2 schematically illustrate a first embodiment of an arrangement 10 of the invention adapted for converting kinetic energy of ocean or river currents into electric energy, e.g. for rotating an electric generator for generating electric power. The arrangement 10 comprises a floating vessel in form of two parallel, elongate pontoon bodies 12 interconnected by an upper deck 14 and a lower deck 16. The pontoon bodies 12 and the decks 14, 16 define a central through-passage 18 for sea water currents when the vessel is anchored in the sea. For use in unidirectional water flows, such as rivers, one end of the pontoon bodies 12 has a tapered shape formed by a respective inclined wall 20 thereof, which walls together define a narrowing water intake 22 to the through-passage 18. The intake 22 has an outer inlet opening 24 with a cross-sectional area substantially greater than the cross-sectional area of the through-passage 18. This will bring about an increased speed of the water flow through the passage 18 which is utilized in a manner described below.

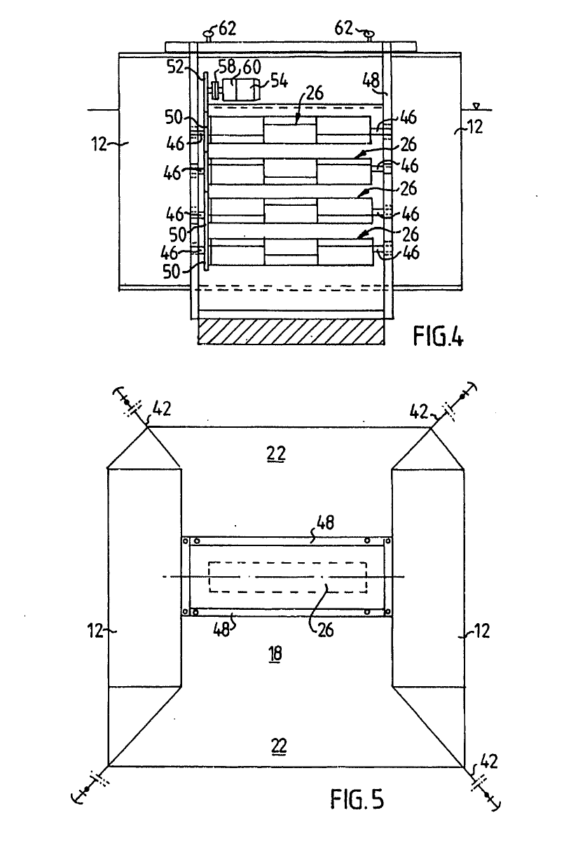

As shown in FIGS. 1 and 2, in the arrangement 10 of the invention there are mounted an even number (in this case four), or pairs, of so called Savonius turbines 26 on the upper deck 14. These turbines 26 extend vertically and downwardly from the upper deck 14 into the through-passage 18 and have an elongated cylindrical configuration with three longitudinally adjacent rotor sections 28, 30, 32, each of which having at least two circumferentially equally spaced vanes or blades 34 with a substantially semi-circular cross-section, as shown in FIG. 3. The blades 34 in the three adjacent rotor sections 28, 30, 32 are preferably mutually circumferentially spaced 360°/3, i.e. 120°, so as to rotate evenly. The turbines 26 are thus suspended in the upper deck 14 and extend in a common vertical plane across the through-passage 18 by means of a respective shaft 36 and carry at their lower ends a counterweight 38 to dampen any pendulum movements. In order to minimize lateral pendulum movements of the turbines 26 caused by the so called Magnus effect indicated with a force arrow y directed normal to the force arrow x caused by the water pressure, the blades 34 of the adjacent turbines 26 are arranged such that the latter will rotate in opposite directions, as indicated with the arrows D1 and D2 in FIG. 3 so as to even out the oppositely directed lateral forces y exerted on the turbines. The turbines 26 should be mutually spaced a distance of at least ⅓ of the diameter of the turbine in order to reduce vortex disturbances between them. Each Savonius turbine 26 is mechanically connected through its shaft 36 to a respective electric power generating unit 40 mounted on top of the upper deck 14. The units 40 may together with the Savonius turbines 26 be detached from the upper deck 14 and lifted away for service or replacement by help of a lifting eye bolt 37.

The pontoons bodies 12 of the embodiment in FIGS. 1 and 2 are shaped to provide a narrowing water intake only at one end and are therefore adapted to be anchored by chains 42 in a river with this end facing upstream. In environments where the tide creates water currents in opposite directions, both ends of the pontoon bodies may have a narrowing water intake, such is disclosed in FIG. 5.

FIGS. 4 and 5 illustrate a second embodiment of the arrangement of the present invention. In contrast to the first embodiment, the Savonius turbines 26 are here arranged horizontally across the through-passage 18 in a substantially common vertical plane normal to the longitudinal axis of the vessel. Both ends of the turbines 26 are rotatably supported over shafts 46 in a framework 48 detachably mounted to the pontoon bodies 12. This double-ended support of the turbines 26 prevents individual pendulum movements thereof. As in the first embodiment, there are provided an even number of Savonius turbines 26 (four), and the adjacent turbines are rotatable in opposite directions to minimize vertical rocking movements of the vessel. All turbines 26 may be kinetically connected over mutually engaging gear wheels 50 at one end shaft 46 thereof. The uppermost gear wheel 50 drivingly engages a gear wheel 52 of a common electric generator 54 mounted above a deck plate 56. Between the generator 54 and the gear wheel 52 there are arranged a clutch 58 and a gearbox 60. In order to carry out repairs and service works the framework 48 may together with the turbines 26 and the electric power generating elements be detached from the pontoon bodies 12 and lifted away by help of lifting eye bolts 62 on the framework 48. Furthermore, both end portions of the pontoon bodies 12 are shaped with tapered or narrowing water intakes for use in typical tide environments, where the direction of the water flow or current frequently changes 180°. Also, anchoring chains 42 are here provided at both ends of the floating vessel.

Owing to the fact that the width W₁ of the outer inlet opening 24 of the narrowing water intake 22 is greater than the width W₂ of the through-passage 18, the speed of the water flowing through the passage will increase theoretically with a factor W₁:W₂. In practice, there are of course some energy losses which reduce this factor, but the power outlet of the generators will increase substantially with the third power of the water flow speed which is especially important when used in waters with low flow speeds, such as the case in most sea environments.

1. An arrangement for converting kinetic energy of ocean currents into electric energy, comprising
a floating body carrying a plurality of turbines, each turbine having an elongated cylindrical configuration and comprising at least three longitudinally adjacent, consecutive turbine rotor sections, each of which sections having at least two blades with a substantially semi-circular cross-section, the blades in adjacent rotor sections being preferably mutually circumferentially spaced 360°/n, where n is the number of the longitudinally adjacent turbine rotor sections,
each turbine further including a rotor shaft at one end thereof for transferring a rotary motion of the turbine to an electric power generating unit on the floating body through a mechanical transmission, and
wherein the floating body comprises at least two parallel, elongated, mutually spaced, interconnected pontoons and defining between the pontoons a narrowed through-passage for water currents, and that at least one pair of turbines being suspended vertically across the through-passage so as to extend downwardly from an upper deck into the through-passage and configured to rotate in opposite directions.

2. An arrangement for converting kinetic energy of ocean currents into electric energy, comprising
a floating body carrying a plurality of turbines, each turbine having an elongated cylindrical configuration and comprising at least three longitudinally adjacent, consecutive turbine rotor sections, each of which sections having at least two blades with a substantially semi-circular cross-section,
the blades in adjacent rotor sections being mutually circumferentially spaced 360/n, where n is the number of the longitudinally adjacent turbine rotor sections,
each turbine further including a rotor shaft for transferring a rotary motion of the turbine to an electric power generating unit through a mechanical transmission,
the floating body comprises at least two parallel, elongated, mutually spaced, interconnected pontoons and defining between the pontoons a narrowed through-passage for water currents, and that at least one pair of turbines being rotatably mounted at opposite ends in the pontoons so as to extend horizontally above each other across the through-passage and configured to rotate in opposite directions.

3. The arrangement of claim 1, wherein at least the one end portion of each pontoon has a tapered shape to define a narrowing water intake to the through-passage such that the cross-sectional area of an inlet opening of the intake is substantially greater than the cross-sectional area of the through-passage.

4. The arrangement of claim 3, wherein two or more pairs of oppositely rotatable turbines are arranged side-by-side in a common vertical plane across the through-passage.

5. The arrangement of claim 4, wherein the turbines are mutually separated a distance of at least ⅓ of the diameter of the turbine.

6. The arrangement of claim 5, wherein the turbines are rotatably supported in a separate framework mounted to inwardly facing side walls of the pontoons.

7. The arrangement of claim 6, wherein one end shaft of the rotor shaft of the turbines carries a gear wheel, such that adjacent gear wheels engage with one another thereby rotating in opposite directions and coupled to an upper gear wheel connected to the electric power generating unity.

8. The arrangement of claim 7, wherein the turbines are Savonius turbines.

9. The arrangement of claim 2, wherein at least the one end portion of each pontoon has a tapered shape to define a narrowing water intake to the through-passage, wherein the cross-sectional area of an inlet opening of the intake is substantially greater than the cross-sectional area of the through-passage.

10. The arrangement of claim 9, wherein two or more pairs of oppositely rotatable turbines are arranged side-by-side in a common vertical plane across the through-passage.

11. The arrangement of claim 10, wherein the turbines are mutually separated a distance of at least ⅓ of the diameter of the turbine.

12. The arrangement of claim 11, wherein the turbines are rotatably supported in a separate framework mounted to inwardly facing side walls of the pontoons.

13. The arrangement of claim 12, wherein one end shaft of the rotor shaft of the turbines carries a gear wheel, such that adjacent gear wheels engage with one another thereby rotating in opposite directions and coupled to an upper gear wheel connected to the electric power generating unit.

14. The arrangement of claim 13, wherein the turbines are Savonius turbines.

15. The arrangement of claim 1, wherein two or more pairs of oppositely rotatable turbines are arranged side-by-side in a common vertical plane across the through-passage.

16. The arrangement of claim 1, wherein the turbines are mutually separated a distance of at least ⅓ of the diameter of the turbine.

17. The arrangement of claim 1, wherein the turbines are Savonius turbines.

18. The arrangement of claim 2, wherein the turbines are rotatably supported in a separate framework mounted to inwardly facing side walls of the pontoons.

19. The arrangement of claim 2, wherein one end shaft of the rotor shaft of the turbines carries a gear wheel, such that adjacent gear wheels engage with one another thereby rotating in opposite directions and coupled to an upper gear wheel connected to the electric power generating unit.
